(19) United States
(12) Patent Application Publication
(10) Pub. No.: US 2026/0007090 A1
(43) Pub. Date: Jan. 8, 2026

(54) AGRICULTURAL SEED METERS AND RELATED DEVICES, SYSTEMS AND METHODS

(71) Applicant: Ag Leader Technology, Ames, IA (US)

(72) Inventors: Alan F. Barry, Nevada, IA (US); Tony Woodcock, Ames, IA (US); Scott Eichhorn, Ames, IA (US)

(21) Appl. No.: 19/260,159

(22) Filed: Jul. 3, 2025

Related U.S. Application Data
(60) Provisional application No. 63/667,530, filed on Jul. 3, 2024.

(51) Int. Cl. A01C 7/04

(52) U.S. Cl. CPC A01C 7/042

(57) ABSTRACT

An agricultural seed meter comprising a seed meter and a monitoring system. The seed meter comprising a seed meter cover, a seed disc, and a singulator assembly. The monitoring system comprising a camera assembly configured to view internal components of the seed meter, a processor in communication with the camera assembly, and a machine vision algorithm executed on the processor, wherein the machine vision algorithm processes images from the camera assembly to detect planting errors.

### CROSS-REFERENCE TO RELATED APPLICATION(S)

This application claims the benefit under 35 U.S.C. § 119(e) to U.S. Provisional Application 63/667,530, filed Jul. 3, 2024, and entitled Agricultural Seed Meters and Related Devices, Systems and Methods, which is hereby incorporated herein by reference in its entirety for all purposes.

### TECHNICAL FIELD

The disclosure relates to agricultural seed meters having a monitoring system and related devices.

### BACKGROUND

As would is generally understood during planting, a seed metering system is used to pull seeds from the seed hoppers and into the meter and seed tube to be deposited in the seed trench. During planting the seeds are singulated (undergo singulation) to ensure one seed, and only one seed, is planted at each location. The ability to plant individual seeds at the correct spacing is done by adjusting the speed of the seed disk and vacuum pressure in correlation with planting speed (vehicle/implement speed) and desired spacing.

FIG. 1 shows an exemplary known seed disk 20 with apertures 22 and other features that correspond with the type of seed being used, here the disk 20 is used for planting corn seeds. As the disk 20 rotates, seeds are held within these spaces 22 via vacuum pressure until the seeds are dropped down the seed tube. As would be generally understood, different seeds require different amounts of vacuum pressure when planting. Presently, the operator must rely on a population monitor (also referred to as a seed sensor) to assess if vacuum pressure needs to be adjusted (e.g., lowered to reduce doubles or raised to reduce skips).

Additionally, brushes (shown at 24 in FIG. 5) may be used to push seeds into the spaces 22 on the seed disk 20 while simultaneously removing any extra seeds from each space 22. This process can reduce the number of doubles occurring during planting. Once a seed is set on the seed disk 20, it moves through the meter 16 until it reaches the seed tube where vacuum pressure is released, and the seed is dropped down the seed tube, as in generally understood.

FIG. 2 shows an exemplary cross section of a seed meter 16 and seed tube 10. As can be seen, the seed tube 10 is a hollow cylinder that aids in guiding seeds from the seed meter 16 to an exit point 18 and into the seed trench. In a gravity drop system the seed are in freefall until they reaches the bottom of the trench. Alternatively, a mechanical delivery system includes a rotating belt 14 that carries the seed down the tube 10 and into the seed trench.

As the seed moves down the tube 10, through either method, a population monitor/seed sensor 12 is triggered and records how many seeds have passed in that instance and the time between two seeds passing. The sensor 12 detects when multiple seeds are present at the same point of time indicating a double and if too much time has passed between seeds, indicating there is a skip. By collecting this data, the singulation and spacing of seeds can be calculated and reported to the operator.

The process of metering seed is not visible to the operator. The operations occur in an enclosed housing preventing visual confirmation that the seed metering system is operating as intended and limiting the diagnostic potential when errors occur during operation. Without seeing the meter 16 in action, operators cannot identify if errors occur due to lack of properly set vacuum pressure, seed disk 20 speed, seed shape, seed disk 20 type, and/or a manufacturing error in the meter 16.

As would be appreciated, planting is time sensitive work and unnecessary time spent on determining faults in the metering system can have a direct effect on harvest yields.

### BRIEF SUMMARY

Disclosed herein are various seed metering and planting systems including monitoring and detecting systems for detecting, analyzing, and correcting metering and planting errors.

In Example 1, an agricultural seed meter monitoring system comprising a seed meter cover, at least one vision sensor configured to record data during operation of a seed meter, and a machine vision algorithm configured to accept data from the at least one vision sensor and configured to detect planting errors, wherein planting errors include double, skips, and improper spacing.

Example 2, relates to the agricultural seed meter of any of Examples 1 and 3-9, further comprising an operations system housing the machine vision algorithm.

Example 3, relates to the agricultural seed meter of any of Examples 1-2 and 4-9, further comprising a GPS in communication with the operations system.

Example 4, relates to the agricultural seed meter of any of Examples 1-3 and 5-9, wherein the operations system assigns GPS coordinates to each seed as it is planted and planting errors.

Example 5, relates to the agricultural seed meter of any of Examples 1-4 and 6-9, further comprising a display in communication with the at least one vision sensor, the display configured to display images from the at least one vision sensor.

Example 6, relates to the agricultural seed meter of any of Examples 1-5 and 7-9, wherein the at least one vision sensor is mounted to the seed meter cover.

Example 7, relates to the agricultural seed meter of any of Examples 1-6 and 8-9, wherein the at least one vision sensor is mounted to a wall retainer brush.

Example 8, relates to the agricultural seed meter of any of Examples 1-7 and 9, wherein the at least one vision sensor is mounted to a wall of the seed meter.

Example 9, relates to the agricultural seed meter of any of Examples 1-8, wherein the at least one vision sensor is mounted to a singulator assembly.

In Example 10, an agricultural seed meter comprising a seed meter and a monitoring system. The seed meter comprising a seed meter cover, a seed disc, and a singulator assembly. The monitoring system comprising a camera assembly configured to view internal components of the seed meter, a processor in communication with the camera assembly, and a machine vision algorithm executed on the processor, wherein the machine vision algorithm processes images from the camera assembly to detect planting errors.

Example 11 relates to the agricultural seed meter of any of Examples 10 and 12-19, wherein the camera assembly is mounted to the seed meter cover.

Example 12 relates to the agricultural seed meter of any of Examples 10-11 and 13-19, wherein the camera assembly comprises at least two cameras.

Example 13 relates to the agricultural seed meter of any of Examples 10-12 and 14-19, wherein the camera assembly comprises four or more cameras.

Example 14 relates to the agricultural seed meter of any of Examples 10-13 and 15-19, wherein planting errors include double, skips, and improper spacing.

Example 15 relates to the agricultural seed meter of any of Examples 10-14 and 16-19, wherein the machine vision algorithm processes images from the camera assembly to further detect manufacturing defects and component wear.

Example 16 relates to the agricultural seed meter of any of Examples 10-15 and 17-19, wherein the machine vision algorithm upon detecting a planting error automatically adjusts settings of one or more components of the seed meter.

Example 17 relates to the agricultural seed meter of any of Examples 10-16 and 18-19, wherein adjustment include one or more of vacuum pressure and disk speed.

Example 18 relates to the agricultural seed meter of any of Examples 10-17 and 19, further comprising a GPS in communication with the processor, wherein the monitoring system locates planting errors.

Example 19 relates to the agricultural seed meter of any of Examples 10-18, wherein the machine vision algorithm is a machine learning algorithm.

In Example 20, system for monitoring and controlling a seed meter comprising a seed meter, a monitoring system, and a GPS. The seed meter, comprising a removeable seed meter cover, a seed disc, a singulator assembly, and at least one brush. The monitoring system, comprising a camera assembly comprising at least two cameras mounted to the removeable seed meter cover configured to view one or more of the singulator assembly and the seed disk, a processor in communication with the camera assembly, and a machine vision algorithm executed on the processor configured to accept data from the camera assembly and configured to detect planting errors, The GPS in communication with the monitoring system, wherein the monitoring system is configured to geolocate detected planting errors.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 shows a seed disk, according to one implementation.

FIG. 2 show a seed meter and seed tube, according to one implementation.

FIG. 3 is a schematic overview of the system on a vehicle, according to one implementation.

FIG. 4 is a system diagram, according to one implementation.

FIG. 5 is a perspective view of the camera assembly on a seed meter cover, according to one implementation.

FIG. 6 is a perspective view of a seed meter cover and seed meter with disk, according to one implementation.

FIG. 7 is a perspective view of a seed meter with seed disk overlay, according to one implementation.

FIG. 8 is a top perspective view of the seed meter and camera, according to one implementation.

FIG. 9A is a view from a camera in the camera assembly, according to one implementation.

FIG. 9B is a view from a camera in the camera assembly, according to one implementation.

FIG. 9C is a view from a camera in the camera assembly, according to one implementation.

FIG. 9D is a view from a camera in the camera assembly, according to one implementation.

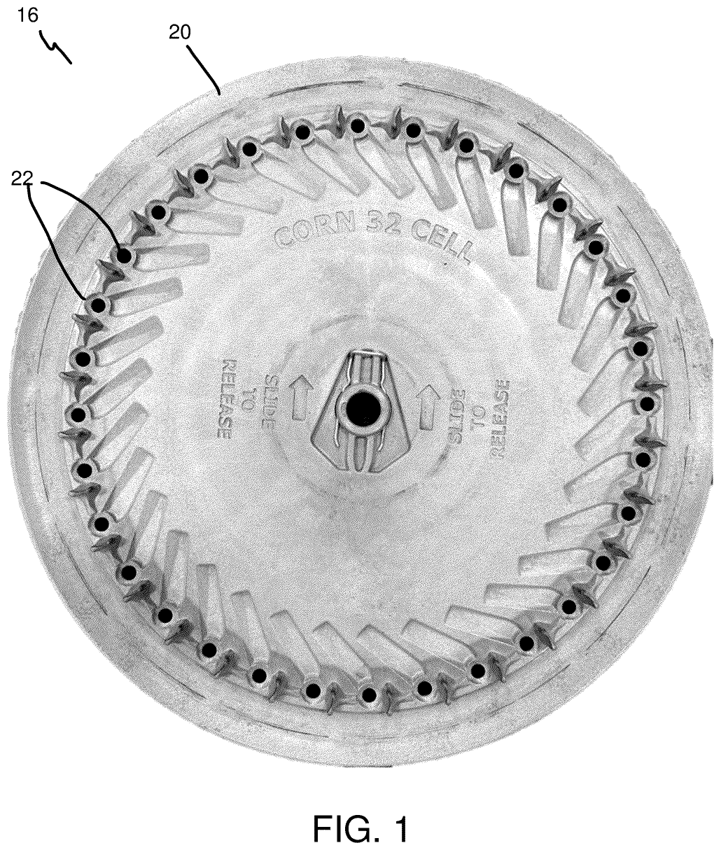

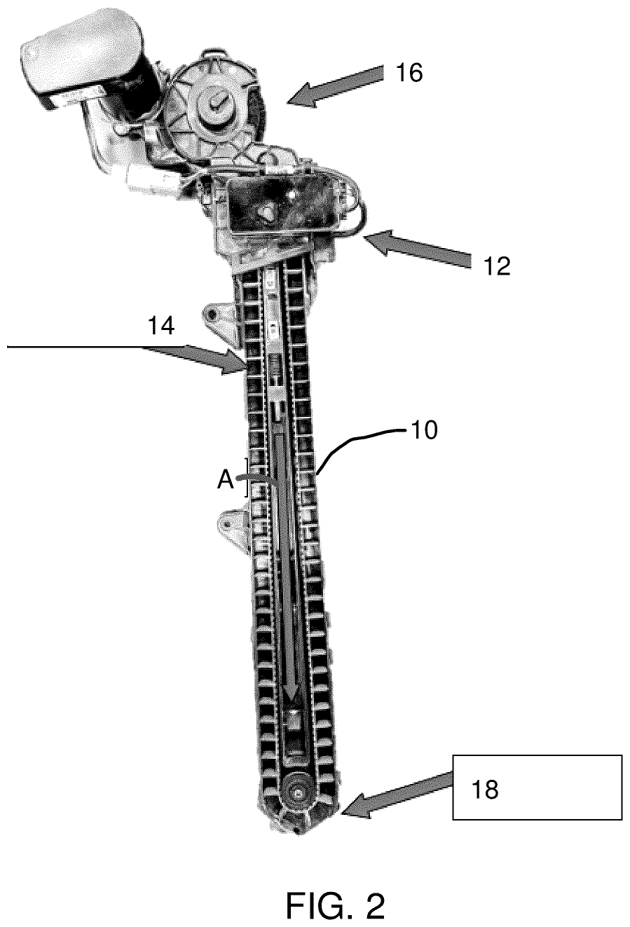

### DETAILED DESCRIPTION

Disclosed herein are various planters, metering systems, and components thereof configured to monitor internal components of a seed meter to indicate errors, troubleshoot, diagnose, and correct various errors. In various implementations, one or more vision sensors are deployed within an agricultural seed meter and are in communication with a processor/operations system to analyze images during operation for detection of errors and defects.

The various devices, systems, and methods may be employed to cut down on the time spent troubleshooting the metering system as well as monitoring the seed while it is inside the meter. In certain implementations, multiple vision sensors and computer vision, machine vision, and/or a machine learning algorithm are employed. By monitoring the seeds when they enter the seed meter, when they are drawn into the seed disk by vacuum, and when they exit into the seed tube the system can identify and determine the cause of various planting errors. Additionally, the system is capable of verifying whether the population monitor/seed sensor, discussed above, is accurate in detecting planting anomalies, including double and skips. As would be appreciated in light of this disclosure, the methods, systems, and devices disclosed herein increase efficiency and decrease downtime during planting operations.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. Patent Application 17/132, 152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. Patent Application 17/724, 120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed February 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/776,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. Patent Application 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. Patent Application 63/685,000, filed Aug. 20, 2024, entitled “Crop Sensor Wands and Related Devices, Systems, and Methods,” U.S. Patent Application 63/682,229, filed Aug. 12, 2024, entitled “Integrated Crop Sensor and GPS Steering Systems and Related Devices and Methods,” U.S. Patent Application 63/710,492, filed Oct. 22, 2024, entitled “Crop Sensors and Related Devices, Systems, and Methods,” U.S. Patent Application 63/710,641, filed Oct. 23, 2024, entitled “Agricultural Sprayer Boom Flush, Chemical Detection and Chemical Concentration Detection,” U.S. Patent Application 63/720,611, filed Nov. 14, 2024, entitled “Liquid Product Distribution for See and Spray Systems,” U.S. Patent Application 63/722,916, filed Nov. 20, 2024, entitled “Agricultural Harvesting Systems and Related Devices and Methods,” U.S. Patent Application 63/722,934, filed Nov. 20, 2024, entitled “Sprayer PWM Nozzle Valve Pressure Drop Mitigation,” U.S. Patent Application 63/723,400, filed Nov. 21, 2024, entitled “Systems, Methods and Devices for Increasing Machine Operating Range Using PWM and Dynamic Pressure Range Control,” U.S. Patent Application 63/727,579, filed Dec. 3, 2024, entitled “Smart Shift for Automatic AB Line Adjustment in Agricultural Operations and Related Devices and Methods,” U.S. Patent Application 63/752,279, filed Jan. 31, 2025, entitled “System and Automatic Adjustment to Target Pressure and Related Devices and Methods,” U.S. Patent Application 63/752,341, filed Jan. 31, 2025, entitled “Harvester Liquid Application System, Devices, and Methods,” U.S. Patent Application 63/753,258, filed Feb. 3, 2025, entitled “Agricultural Navigation Methods, Devices, and Systems,” U.S. Patent Application 63/753,201, filed Feb. 3, 2025, entitled “Agricultural Mapping and Related Devices, Systems, and Methods” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,” each of which is incorporated herein by reference.

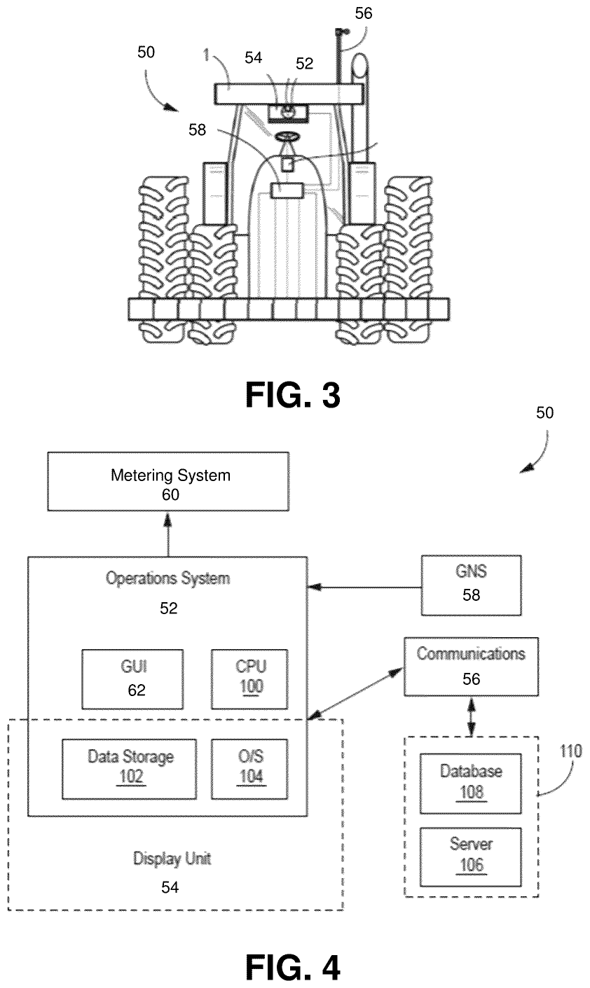

Turning to the drawings in greater detail, FIGS. 3-4 depict exemplary implementations of the monitoring system 50 components fitted to an agricultural vehicle 1. In various implementations, the agricultural vehicle 1 may be a tractor 1 optionally having an implement such as a planter, as would be understood. It is further understood that the components depicted in FIGS. 3-4 are optional, and can be utilized or omitted in the various implementations, and that certain additional components may be required to effectuate the various processes and systems described herein. Such additional components may include hardware, software, firmware, and other electronic components that would be known and appreciated by those of skill in the art.

As shown in FIG. 3, the monitoring system 50 has an operations system 52 that comprises an optional communications component 56. The system 50 is operationally integrated with at least one in-cab display 54, such as an InCommand® display 54, or other suitable display 54 understood in the art. It is appreciated that certain of these displays 54 feature a graphical user interface (GUI) 62, touchscreens, while others are equipped with necessary components for interaction with the various prompts and adjustments discussed herein, such as via a keyboard or other interface.

In various implementations, the system 50 is also operationally integrated with a GNSS or GPS unit 58, such as a GPS 7500, such that the system 50 is configured to identifying locations of adverse conditions/events, and the like, as would be readily appreciated.

As shown in FIG. 4, in various implementations, the operations system 52 is optionally in operational communication with a metering system 60, the communications component 56, and/or GNSS 58. In certain of these implementations, the operations system 52 is housed in the display 54, though the various components described herein can be housed elsewhere, as would be readily appreciated.

As shown in FIG. 4, the operations system 52 further has one or more optional processing and computing components, such as a CPU/processor 100, data storage 102, operating system 104, and other computing components necessary for implementing the various technologies disclosed herein. It is appreciated that the various optional system 50 components are in operational communication with one another via wired or wireless connections and are configured to perform the processes and execute the commands described herein.

In certain implementations, like that of FIG. 4, the communications component 56 is configured for the sending and receiving of data for cloud 110 storage and processing, such as to a remote server 106, database 108, and/or other cloud computing components readily understood in the art. Such connections by the communications component 56 can be made wirelessly via understood internet and/or cellular technologies such as Bluetooth, WiFi, LTE, 3G, 4G, or 5G connections and the like. It is understood that in certain implementations, the communications component 56 and/or cloud 110 components comprise encryption or other data privacy components such as hardware, software, and/or firmware security aspects. In various implementations, the operator or enterprise manager or other third parties are able to receive notifications such as adjustment prompts and confirmation screens on their mobile devices, and in certain implementations can review the imaging and related data and make adjustments via their mobile phones or other remote devices.

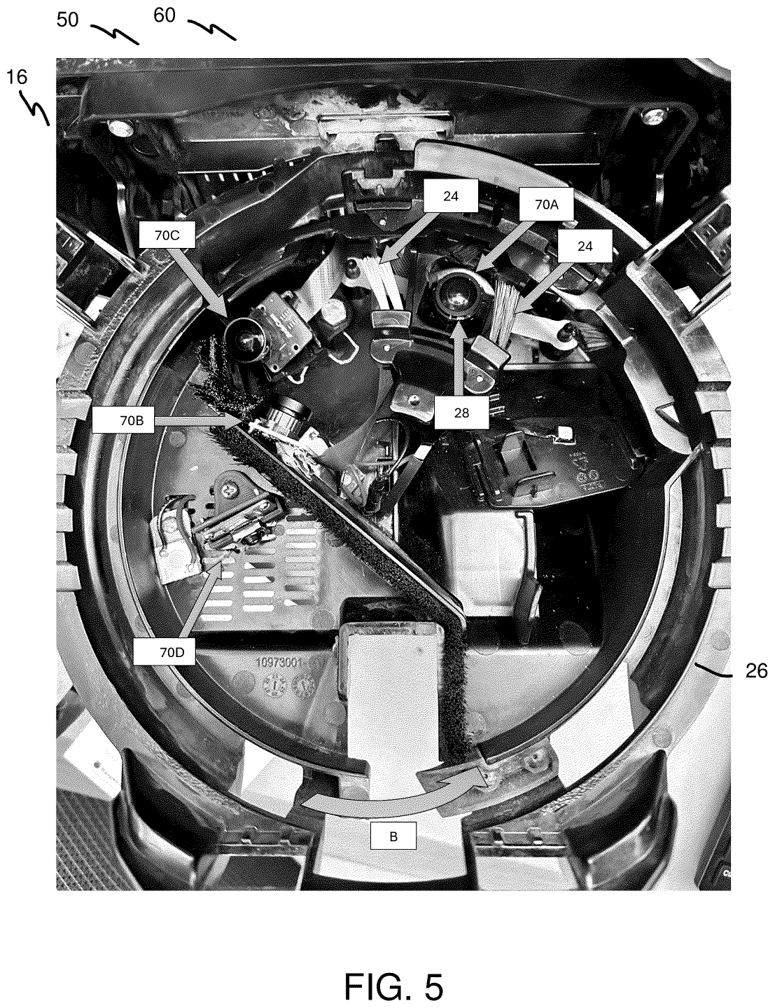

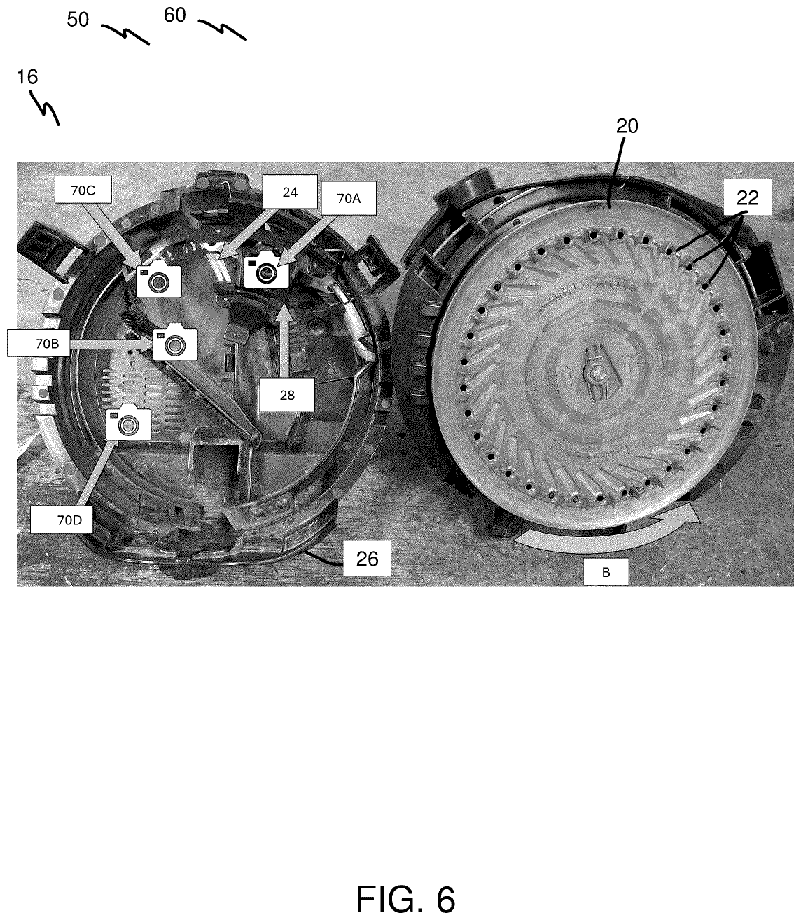

Turning to FIGS. 5 and 6, in various implementations, vision sensors 70A-D, hereinafter known as cameras 70A-D, may be placed in, but not limited to, areas such as adjacent to the singulator assembly 28 or on the singulator assembly 218 (camera 70A) and/or along the meter 16 housing wall 26 (cameras 70B-D) to achieve various view of the inside of the seed meter 16 without disturbing the performance of the seed meter 16. The cameras 70A-D may feature a multitude of lenses in various fields of view to capture clear images of the seed meter 16 in detail. Arrow B shows the direction of rotation of the disc 20/meter 16.

Although various camera 70 placements are possible, one exemplary implementation including four cameras 70 is shown in FIGS. 5 and 6, where the cameras 70 positioning yield a complete view of the internal components of the seed meter 16 and metering system 60.

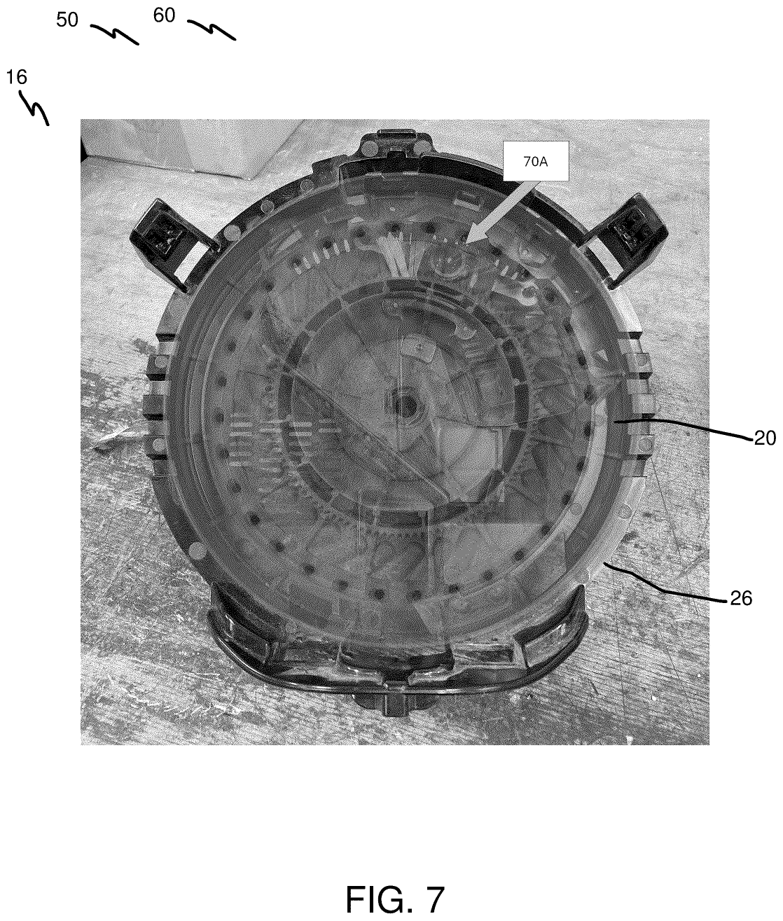

FIG. 7 shows an exemplary seed meter 16 and camera 70A positioned with the seed disk 20.

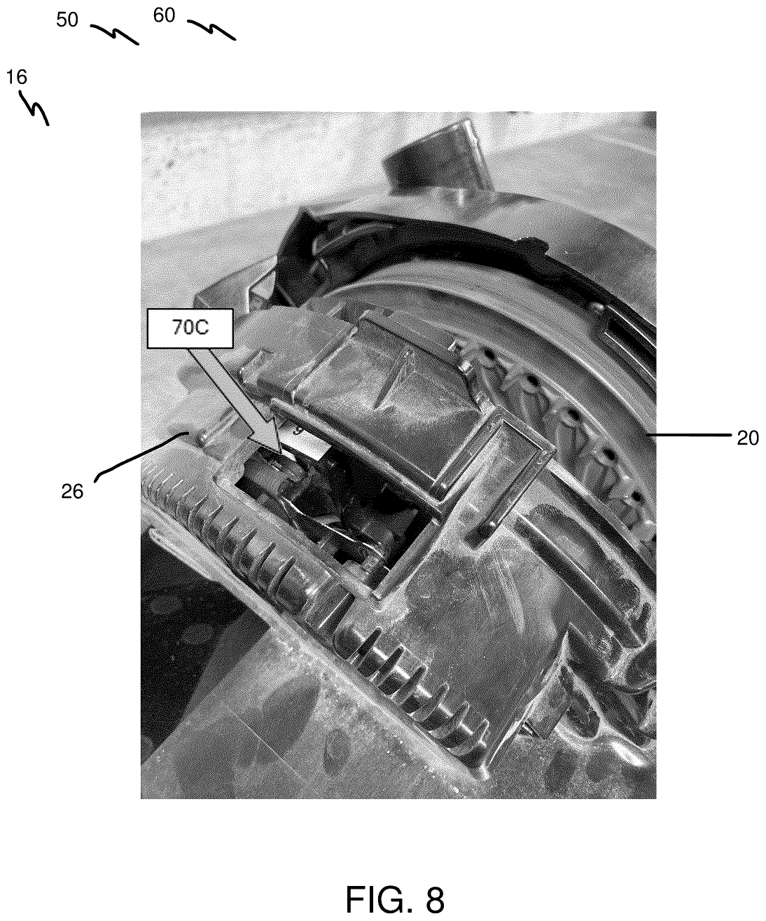

FIG. 8 shows an further exemplary seed meter 16 and camera 70C position with the seed disk 20 and cover 26.

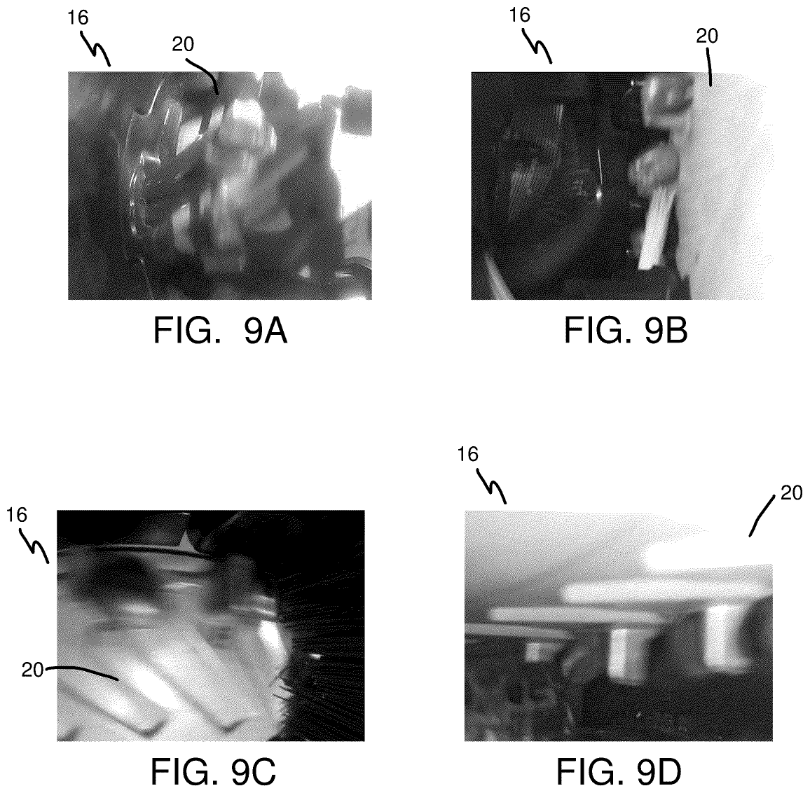

FIGS. 9A-D show various exemplary images from the vision sensors 70 shown in FIG. 5.

FIG. 9A shows an image from camera 70A. In this example camera 70A includes a 180-degree wide angle lens, mounted to the singulator assembly 28 having a view perpendicular to the seed disc 20.

FIG. 9B shows an image from camera 70B. In this example camera 70B includes a 120-degree wide angle lens, mounted to the wall brush 24 retainer wall having a view parallel to the seed disc 20.

FIG. 9C shows an image from camera 70C. In this example camera 70C includes a 150-degree wide angle lens, mounted to a block attached to the meter wall 26 having a view of the singulator 28 and meter housing transition.

FIG. 9D shows an image from camera 70D. In this example camera 70D includes a 120-degree angle self-focusing lens, mounted to a bracket attached to the meter wall 26 having a view of the seed disc 20 to stripper wheel transition.

In various implementations, all of the cameras 70 are mounted to the removable portion of the meter housing 26 such that the cameras 70 can be secured on and taken off one meter 16 and moved to other meters 16 as needed to monitor metering system 60 performance across the planter. That is, it would be generally understood that a seed meter 16 includes a removable cover 26 for access to the interior portions of the seed meter 16 for conducting diagnostics and maintenance. In various implementations, the vision sensors 70 are mounted to the removable cover 26 such that the cover 26 having mounted vision sensors 70 may be placed on various different seed meters 16 at different times.

In these an other implementations, a planter may include one or more camera assemblies, monitoring one or more individual seed meters 16 at a given time. Further, the camera assembly may be retrofitted on various different seed meters 16. This would also allow the camera assembly and monitoring system 50 to be adapted to assorted brands of seed meters 16 such as Ag Leader® SureSpeed®.

The type of camera 70 used in conjunction with the monitoring system 50 may include, but is not limited to, those in the visible light spectrum and those outside that range such as infrared cameras. Various alternative visions sensors 70 are possible and would be understood by those of skill in the art.

In various implementations, the cameras 70 are connected to a viewing display 54 or a monitor such as InCommand® from Ag Leader®. On the display 54, the images taken inside the seed meter 16 may be replayed at slow motion, full speed, or as individual pictures depending on the operator's needs or system 50 setup. Furthermore, multiple views of the meter 16 may be connected to form a continuous image to be viewed in addition to the single views of each camera 70 location.

In various implementations, the monitoring system 50 may include a computer vision/machine vision/machine learning algorithm to observe the meter 16 operations. That is a computer vision/machine vision/machine learning algorithm may process and view the data from the vision sensors 70 to detect and analyze planting issues/errors. Use of the computer vision/machine vision/machine learning algorithm may allow the operator to focus on the planting process and have the performance of the seed meters 16 analyzed in real time, near real-time, or subsequent to operations. Should adjustments need to be made to the seed meter 16, such as vacuum pressure, the computer vision/machine vision/machine learning algorithm may recommend what adjustments to make and/or automatically adjust settings based on the current calibration and singulation with or without operator guidance.

As the computer vision/machine vision/machine learning algorithm views each seed the computer vision/machine vision/machine learning algorithm may automatically collect data and calculate various types of information that may be of use to the operator such as, but not limited to, percentage of doubles, skips, type of seed, seed orientation, and refuse visible over a linear distance or other measurement method. This data can then be used to validate the results collected by the seed sensor 12.

For example, if there is an increase in singulation errors, doubles, and skips, detected by the seed sensor 12 and reported to the operator, then the operator can compare that data on the display 54 with the images collected by the monitoring system 50. For example, the monitoring system 50 and the seed sensor 12 report the same singulation, then there may be an issue with the calibration settings of the seed meter 16. However, if the monitoring system 50 and the seed sensor 16 report different singulations, then there may be a problem in the area where the seed enters the seed tube. By using the monitoring system 50 the operator can quickly solve seed meter 16 and planting errors or alternatively the system 50 may be able to automatically resolve seed meter 16 and planting errors.

In certain implementations, the monitoring system 50 may be used in place of a seed sensor when planting.

In some implementations, the monitoring system 50 may have geospatial (i.e., GPS 58) capabilities to monitor the placement of the seeds within a field. This would allow the computer vision/machine vision/machine learning algorithm to calculate the spacing of each seed beyond the usual method of using a seed sensor 12 and attach GPS 58 data to each seed. The system 50 identify where doubles and skips occur in the field and monitor the health of their crops during the growing season. This feature may be connected to a larger system such as AgFiniti® from Ag Leader® to compare planting conditions with harvest yields in a growing season and across multiple years. As data is collected on farming practices farmers and operators have access to data that allows them to make their own precision farming decisions and/or allow various systems including the monitoring system and various other systems such as those disclosed in the incorporated references to automatically make decisions and take action to improve farming efficiency.

In various implementations, the monitoring system 50 may be used while the meter 16 is stationary on a test stand for diagnostic purposes, and during field planting to verify planting quality. The ability to use the monitoring system while actively planting allows an operator to have confidence that their metering system 60 is working correctly and maintaining performance standards. Should issues arise while planting regarding the metering system 60 condition, the operator can view the internal mechanisms of the meters 16 to assess a course of action to rectify the problem or alternatively the monitoring system 50 may automatically take corrective action. Using the monitoring system 50 while operating a planter would also allow the operator to view how different seed meter 16 settings affect seed placement and singulation, expanding their understanding of the seed metering system 60.

The uses of the monitoring system 50 may be used to monitor and detect manufacturing errors. Errors during manufacturing can adversely affect the ability of the seed meter 16 to perform correctly, even minor errors may cause it to stall. By using the computer vision/machine vision/machine learning algorithm of the monitoring system 50, the monitoring system 50 may identify when parts inside of the meter 16 have manufacturing errors or wear out. This may include, but is not limited to, assessing if the meter housing is warped or if the brushes inside the meter have been cut incorrectly. This is useful for manufacturers as a form of quality control so that their metering systems 60 are in working order before they reach customers. When detected the system 50 may automatically order replacement parts and/or notify the operator of the need for replacement parts.

Farm machinery dealers may also find use in the monitoring system as a method to troubleshoot their customer's seed metering system 60 problems as well as a tool to teach new planting techniques to operators. Because in various implementations the camera assembly or the monitoring system 50 is removable and can be placed on seed meters 16 across different row units a dealer can service their customers' meter systems 60 directly and efficiently to their customer's needs. Additionally, as seed meter systems 60 are used, parts can become worn and require maintenance to maintain proper operating condition. By monitoring the wear within a seed 16 meter data can be collected on how wear patterns can affect seed placement and singulation when planting. Identifying unusual wear that may be a sign of an improperly set meter 16, manufacturing error, or a design error that can be corrected for future products.

Although the disclosure has been described with references to various embodiments, persons skilled in the art will recognize that changes may be made in form and detail without departing from the spirit and scope of this disclosure.

What is claimed is:

1. An agricultural seed meter monitoring system comprising:
(a) a seed meter cover;
(b) at least one vision sensor configured to record data during operation of a seed meter; and
(c) a machine vision algorithm configured to accept data from the at least one vision sensor and configured to detect planting errors,
wherein planting errors include double, skips, and improper spacing.

2. The agricultural seed meter of claim 1, further comprising an operations system housing the machine vision algorithm.

3. The agricultural seed meter of claim 2, further comprising a GPS in communication with the operations system.

4. The agricultural seed meter of claim 3, wherein the operations system assigns GPS coordinates to each seed as it is planted and planting errors.

5. The agricultural seed meter of claim 1, further comprising a display in communication with the at least one vision sensor, the display configured to display images from the at least one vision sensor.

6. The agricultural seed meter of claim 1, wherein the at least one vision sensor is mounted to the seed meter cover.

7. The agricultural seed meter of claim 1, wherein the at least one vision sensor is mounted to a wall retainer brush.

8. The agricultural seed meter of claim 1, wherein the at least one vision sensor is mounted to a wall of the seed meter.

9. The agricultural seed meter of claim 1, wherein the at least one vision sensor is mounted to a singulator assembly.

10. An agricultural seed meter comprising:
(a) a seed meter comprising:
(i) a seed meter cover;
(ii) a seed disc; and
(iii) a singulator assembly; and
(b) a monitoring system, comprising:
(i) a camera assembly configured to view internal components of the seed meter;
(ii) a processor in communication with the camera assembly; and
(iii) a machine vision algorithm executed on the processor,
wherein the machine vision algorithm processes images from the camera assembly to detect planting errors.

11. The agricultural seed meter of claim 10, wherein the camera assembly is mounted to the seed meter cover.

12. The agricultural seed meter of claim 10, wherein the camera assembly comprises at least two cameras.

13. The agricultural seed meter of claim 10, wherein the camera assembly comprises four or more cameras.

14. The agricultural seed meter of claim 10, wherein planting errors include double, skips, and improper spacing.

15. The agricultural seed meter of claim 10, wherein the machine vision algorithm processes images from the camera assembly to further detect manufacturing defects and component wear.

16. The agricultural seed meter of claim 10, wherein the machine vision algorithm upon detecting a planting error automatically adjusts settings of one or more components of the seed meter.

17. The agricultural seed meter of claim 16, wherein adjustment include one or more of vacuum pressure and disk speed.

18. The agricultural seed meter of claim 16, further comprising a GPS in communication with the processor, wherein the monitoring system locates planting errors.

19. The agricultural seed meter of claim 16, wherein the machine vision algorithm is a machine learning algorithm.

20. A system for monitoring and controlling a seed meter comprising:
(a) a seed meter, comprising:
(i) a removeable seed meter cover;
(ii) a seed disc;
(iii) a singulator assembly; and
(iv) at least one brush;
(b) a monitoring system, comprising:
(i) a camera assembly comprising at least two cameras mounted to the removeable seed meter cover configured to view one or more of the singulator assembly and the seed disk;
(ii) a processor in communication with the camera assembly; and
(iii) a machine vision algorithm executed on the processor configured to accept data from the camera assembly and configured to detect planting errors; and
(c) a GPS in communication with the monitoring system, wherein the monitoring system is configured to geolocate detected planting errors.
